(19) United States
(12) Patent Application Publication
(10) Pub. No.: US 2011/0028640 A1
(43) Pub. Date: Feb. 3, 2011

(54) HARDENABLE COMPOSITIONS BASED ON SILYLATED POLYURETHANES

(75) Inventors: Johann Klein, Duesseldorf (DE); Sara Gonzalez, Barcelona (ES); Lars Zander, Rommerskirchen (DE); Christiane Kunze, Koln (DE); Thomas Bachon, Duesseldorf (DE); Andreas Bolte, Duesseldorf (DE); Martin Majolo, Erkelenz (DE); Thomas Tamcke, Duesseldorf (DE)

Correspondence Address: HENKEL CORPORATION, One Henkel Way, ROCKY HILL, CT, 06067, US

(73) Assignee: Henkel AG & Co. KGaA, Duesseldorf (DE)

(21) Appl. No.: 12/906,215

(22) Filed: Oct. 18, 2010

Related U.S. Application Data
(63) Continuation of application No. PCT/EP2009/055049, filed on Apr. 27, 2009.

(30) Foreign Application Priority Data
Apr. 28, 2008 (DE) 102008021221.0

(51) Int. Cl. C08L 83/08; C08G 77/08

(52) U.S. Cl. 524/588; 528/15; 528/16; 528/19; 528/14; 528/13; 528/17

(57) ABSTRACT

The invention relates to a method for producing cross-linkable formulations. In a first step of the method, at least one α,ω-difunctional organic polymer of formula (1) X-A-X (1) is converted into organyloxysilyl-terminated polymers P1, using organofunctional silanes of formula (2) Y—R—Si—(R¹)ₘ(—OR²)₃ₘ (2), in the presence of catalysts (A) selected from the group consisting of potassium, iron, indium, zinc, bismuth and copper compounds. In said formulae, R is a bivalent, optionally substituted hydrocarbon group which comprises between 1 and 12 carbon atoms and can be interrupted with heteroatoms, R¹ and R² are the same or different, monovalent, optionally substituted hydrocarbon groups which comprise between 1 and 12 carbon atoms and can be interrupted with heteroatoms, A is bivalent, optionally substituted hydrocarbon group which comprises at least 6 carbon atoms and can be interrupted with heteroatoms, m is equal to 0, 1 or 2, X is a hydroxyl group and Y is an isocyanate group, or X is an isocyanate group and Y is a hydroxyl group or a primary or secondary amino group. In a second step, the polymers P¹ obtained in the first step are mixed with a silane condensation catalyst (B) selected from the group consisting of compounds of elements of the third main group and/or fourth secondary group and heterocyclic organic amines, amine complexes of the element compounds, or the mixtures thereof. Optionally, said mixture is mixed with other substances (C). The formulations do not contain organic tin compounds, and are suitable for using as adhesives, sealants, or coating agents.

This application is a continuation of International Application No. PCT/EP20091055049, filed Apr. 27, 2009 and published on Nov. 5, 2009 as WO 2009/133062, which claims the benefit of German Patent Application No. 102008021221.0 filed Apr. 28, 2008, the contents of each of which are incorporated herein by reference in their entirety.

The present invention relates to a method for manufacturing silane-crosslinking curable compositions, and to their use in adhesives and sealants and in coating agents.

Polymer systems that possess reactive alkoxysilyl groups are known. In the presence of atmospheric moisture these alkoxysilane-terminated polymers are capable, already at room temperature, of condensing with one another with release of the alkoxy groups. What forms in this context, depending on the concentration of alkoxysilyl groups and their configuration, are principally long-chain polymers (thermoplastics), relatively wide-mesh three-dimensional networks (elastomers), or highly crosslinked systems (thermosetting plastics).

The polymers generally comprise an organic backbone that carries alkoxysilyl groups at the ends. The organic backbone can involve, for example, polyurethanes, polyesters, polyethers, etc.

One-component, moisture-curing adhesives and sealants have for years played a significant role in numerous technical applications. In addition to the polyurethane adhesives and sealants having free isocyanate groups, and the traditional silicone adhesives and sealants based on dimethylpolysiloxanes, the so-called modified silane adhesives and sealants have also been increasingly used recently. In this latter group, the main constituent of the polymer backbone is a polyether, and the reactive and crosslinkable terminal groups are alkoxysilyl groups. The modified silane adhesives and sealants have the advantage, as compared with the polyurethane adhesives and sealants, of being free of isocyanate groups, in particular of monomeric diisocyanates; they are also notable for a broad adhesion spectrum to a plurality of substrates without surface pretreatment using primers.

U.S. Pat. No. 4,222,925 A and U.S. Pat. No. 3,979,344 A describe siloxane-terminated organic sealant compositions, curable already at room temperature, based on reaction products of isocyanate-terminated polyurethane prepolymers with 3-aminopropyltrimethoxysilane or 2-aminoethyl- or 3-aminopropylmethoxysilane to yield isocyanate-free siloxane-terminated prepolymers. Adhesives and sealants based on these prepolymers have unsatisfactory mechanical properties, however, especially in terms of their elongation and breaking strength.

The methods set forth below for the manufacture of silane-terminated prepolymers based on polyethers have already been described:
Copolymerization of unsaturated monomers with ones that comprise alkoxysilyl groups, for example vinyltrimethoxysilane.
Grafting unsaturated monomers, such as vinyltrimethoxysilane, onto thermoplastics such as polyethylene.
Hydroxyfunctional polyethers are reacted with unsaturated chlorine compounds, e.g. allyl chloride, in an ether synthesis to yield polyethers having terminal olefinic double bounds, which in turn are reacted with hydrosilane compounds that have hydrolyzable groups, for example HSi(OCH₃)₃, in a hydrosilylation reaction under the catalytic influence of, for example, transition metal compounds of the eighth group, to yield silane-terminated polyethers.
In another method, the polyethers containing olefinically unsaturated groups are reacted with a mercaptosilane such as, for example, 3-mercaptopropyltrialkoxysilane.
In a further method, firstly hydroxyl-group-containing polyethers are reacted with di- or polyisocyanates, which are then in turn reacted with aminofunctional silanes or mercaptofunctional silanes to yield silane-terminated prepolymers.
A further possibility provides for the reaction of hydroxyfunctional polyethers with isocyanatofunctional silanes such as, for example, 3-isocyanatopropyltrimethoxysilane.

These manufacturing methods, and the use of the aforementioned silane-terminated prepolymers in adhesive/sealant applications, are recited e.g. in the following patent documents: U.S. Pat. No. 3,971,751 A, EP-A-70475, DE-A-19849817, U.S. Pat. No. 6,124,387 A, U.S. Pat. No. 5,990,257 A, U.S. Pat. No. 4,960,844 A, U.S. Pat. No. 3,979,344 A, U.S. Pat. No. 3,632,557 A, DE-A-4029504, EP-A-601021, or EP-A-370464.

According to the teaching of EP-A-397 036, a polyether is first provided with olefinic terminal groups, e.g. allyl terminal groups, and then preferably reacted with alkoxyhydridosilanes. A catalyst can optionally be used for the curing reaction; examples that may be recited are metal salts of carboxylic acids such as alkyl titanates, tin octoates, dibutyltin laurate (DBTL), amine salts, or other acid or basic catalysts.

EP-A-0931800 describes the manufacture of silylated polyurethanes by reacting a polyol component having a terminal unsaturation of less than 0.02 meq/g with a diisocyanate to yield a hydroxyl-terminated prepolymer, which is then capped with an isocyanatosilane of the formula OCN—R—Si—(X)ₘ(—OR¹)₃₋ₘ, where m is 0, 1, or 2 and each R¹ residue is an alkyl group having 1 to 4 carbon atoms and R is a difunctional organic group. According to the teaching of this document, manufacture of the silylated polyurethanes is to take place under anhydrous conditions, preferably under a nitrogen blanket, dialkyltin dicarboxylates typically being used as a catalyst.

EP-A-153940 describes a method for manufacturing organyloxysilyl-terminated polymers that exhibit elevated stability with regard to atmospheric moisture, by reacting α,ω-dihydroxy-terminated organic polymers with isocyanatofunctional silanes in the presence of at least one catalyst selected from the group consisting of bismuth and zinc compounds, and crosslinkable substances containing such polymers that also contain silane condensation catalysts for curing, the following being recited: dibutyltin dilaurate, dibutyltin diacetate, tetrabutyldimethoxydistannoxane, solutions of dibutyltin oxide in methyltrimethoxysilane or tetraethoxysilane, dioctyltin dilaurate, dioctyltin diacetate, tetraoctyldimethoxydistannoxane, solutions of dioctyltin oxide in methyltrimethoxysilane or tetraethoxysilane, dibutyltin-bis(2,4-pentanedionate), dibutyltin maleate, aminopropyltrimethoxysilane, and aminoethylaminopropyltrimethoxysilane, as well as acid catalysts such as organic carboxylic acids, phosphoric acids and phosphoric acid esters, acid chlorides or hydrochlorides.

A need still exists for isocyanate-free compositions for the manufacture of one- or two-component adhesives and sealants or coating agents that exhibit an acceptable curing time and particularly good elasticity and extensibility after curing, and that are free of organic tin compounds.

The manner in which the object is achieved according to the present invention may be gathered from the Claims. It involves substantially making available a method for manufacturing crosslinkable preparations, encompassing
in a first step, reacting one or more am-difunctional organic polymers of formula (1)

X-A-X (1)
with organofunctional silanes of formula (2)

Y—R—Si—(R¹)ₘ(—OR²)₃₋ₘ (2),
in the presence of catalysts (A) selected from the group consisting of compounds of potassium, iron, indium, zinc, bismuth, and copper, to yield organyloxysilyl-terminated polymers P¹. R in this context is a divalent, optionally substituted hydrocarbon residue having 1 to 12 carbon atoms, which can be interrupted by heteroatoms,
   R¹ and R² can be the same or different, and denote monovalent, optionally substituted hydrocarbon residues having 1 to 12 carbon atoms, which can be interrupted by heteroatoms,
   A is a divalent, optionally substituted hydrocarbon radical having at least 6 carbon atoms, which can be interrupted by heteroatoms, and
   m is equal to 0, 1, or 2, and
   X is a hydroxyl group and Y is an isocyanate group, or X is an isocyanate group and Y is a hydroxyl group or a primary or secondary amino group.
In a second step,
the polymers P¹ obtained in the first step are mixed with a silane condensation catalyst (B) selected from the group consisting of compounds of elements of the third main group and/or of the fourth subgroup of the periodic system of the elements and heterocyclic organic amines, amine complexes of the element compounds, or mixtures thereof, and optionally with further substances (C), the preparations being free of organic tin compounds.

“Substituted” means in this context that at least one of the atoms present as main chain members in a residue is or can be connected to at least one further atom that is not a hydrogen atom or a member of the main chain. An “unsubstituted chain” is consequently to be understood as a residue that is made up of only a single chain, and whose constituent atoms are connected only to further chain members and/or to hydrogen atoms.

“Interrupted by heteroatoms” means that the main chain of a residue comprises, as a chain member, at least one atom differing from carbon.

“Further substances (C)” are to be understood as all substances that, in addition to polymers P¹ and the silane condensation catalyst (B), are also needed in order to manufacture a crosslinkable preparation according to the present invention, neither the number nor the identity of the substance or substances (C) being subject to a limitation.

In the context of the present invention, a plurality of polymers carrying at least two hydroxyl groups can be used in principle as α,ω-difunctional organic polymers of the formula X-A-X, assuming X is equal to —OH. Examples that may be recited are polyester polyols, hydroxyl-group-containing polycaprolactones, hydroxyl-group-containing polybutadienes, polyisoprenes, dimer diols, or OH-terminated polydimethylsiloxanes, as well as hydrogenation products thereof, or also hydroxyl-group-containing polyacrylates or polymethacrylates.

The organic polymers of formula (1) are preferably polymer compounds based on polyethers or polyesters.

Polyalkylene oxides, however, in particular polyethylene oxides and/or polypropylene oxides, are very particularly preferred as polyols.

Polyols that contain polyethers as a polymer backbone possess a flexible and elastic structure not only at the end groups but also in the polymer spine. Compositions that exhibit additionally improved elastic properties can be manufactured therewith. Polyethers are not only flexible in their framework, but also at the same time strong. For example, polyethers (in contrast to e.g. polyesters) are not attacked or decomposed by water and bacteria.

Polyethylene oxides and/or polypropylene oxides are therefore used with particular preference.

According to a further preferred embodiment of the polyol compounds X-A-X to be used according to the present invention, the molecular weight Mₙ is between 500 and 20,000 g/mol (daltons), the terminal unsaturation being less than 0.05 meq/g, preferably less than 0.04 meq/g, and particularly preferably less than 0.02 meq/g.

These molecular weights are particularly advantageous because these polyols are readily available commercially. Molecular weights from 4000 to 10,000 g/mol (daltons) are particularly preferred.

Polyoxyalkylenes, in particular polyethylene oxides or polypropylene oxides, that exhibit a polydispersity PD of less than 2, preferably less than 1.5, are used with very particular preference.

The “molecular weight Mₙ” is understood as the number-average molecular weight of the polymer. This, like the weight-average molecular weight M_{w}, can be determined by gel permeation chromatography (GPC, also called SEC). This method is known to one skilled in the art. The polydispersity is derived from the average molecular weights M_{w} and Mₙ. It is calculated as PD=M_{w}/Mₙ.

Particularly advantageous viscoelastic properties can be achieved if polyoxyalkylene polymers that possess a narrow molecular weight distribution, and thus a low polydispersity, are used as polymer backbones. These can be manufactured, for example, by so-called double metal cyanide (DMC) catalysis. These polyoxyalkylene polymers are notable for a particularly narrow molecular weight distribution, a high average molecular weight, and a very small number of double bonds at the ends of the polymer chains.

Such polyoxyalkylene polymers have a polydispersity PD (M_{w}/Mₙ) of at most 1.7. Particularly preferred organic backbones are, for example, polyethers having a polydispersity from approximately 1.01 to approximately 1.3, in particular approximately 1.05 to approximately 1.18, for example approximately 1.08 to approximately 1.11 or approximately 1.12 to approximately 1.14.

If applicable, the aforementioned polyol compound can be reacted in a previous reaction with a diisocyanate, with a stoichiometric excess of the polyol compounds with respect to the diisocyanate compound, to yield a polyurethane prepolymer that is hydroxyl-terminated. In this case the grouping A in formula (1) contains, in addition to the polyether groups, urethane groupings in the polymer chain. The result is that particularly high-molecular-weight α,ω-difunctional polyols are available for the subsequent reaction.

As α,ω-difunctional organic polymers of the formula X-A-X, for the case in which X is equal to —NCO, α,ω-difunctional polyols of the aforesaid kind can be reacted with a diisocyanate, with a stoichiometric excess of the diisocyanate compounds with respect to the polyol compounds or with respect to the OH groups of the polyol compound(s), to yield a polyurethane prepolymer that is isocyanate-terminated. In this case grouping A in formula (1) also contains, in addition to the polyether groups, urethane groupings in the polymer chain. By selecting the stoichiometric excess of the diisocyanate compound, the molecular weight of the α,ω-diisocyanate-terminated polymer X-A-X can be varied within wide limits and adapted to the requirements of the planned application.

As already stated above, the polyol compounds X-A-X are reacted with organofunctional silanes of the Y—R—Si—(R¹)ₘ(—OR²)₃₋ₘ type, Y in this case being an isocyanate group.

Examples of the divalent residue R are alkylene residues, methylene, ethylene, n-propylene, isopropylene, n-butylene, isobutylene, tert-butylene, n-pentylene, isopentylene, neopentylene, tert-pentylene residue, n-hexylene residue, n-heptylene residue, n-octylene residue, isooctylene residues, 2,2,4-trimethylpentylene residue, n-nonylene residue, n-decylene residue, n-dodecylene residue; alkenylene residues, such as the vinylene and allylene residue; cycloalkylene residues, such cyclopentylene, cyclohexylene, cycloheptylene residues and methylcyclohexylene residues; arylene residues, such as the phenylene and naphthylene residue; alkarylene residues, such as o-, m-, p-tolylene residues, xylylene residues and ethylphenylene residues; aralkylene residues, such as the benzylene residue, the α- and β-phenylethyleneresidue.

Divalent hydrocarbon residues having 1 to 3 carbon atoms are particularly preferred for R. In particular, compounds where R=methylene exhibit high reactivity in the terminating silyl groups, which contributes to shorter curing and hardening times. If a propylene group is selected for R, these compounds then exhibit particularly high flexibility. This property is attributed to the longer connecting carbon chain between the polymer backbone bound via Y and the terminating silyl group, since alkylene groups are generally flexible and movable.

The residues R¹ and R² are by preference, mutually independently, a hydrocarbon residue having 1 to 6 carbon atoms, particularly preferably an alkyl residue having 1 to 4 carbon atoms, in particular the methyl or ethyl residue. Compounds having alkoxysilyl groups exhibit different reactivities in chemical reactions depending on the nature of the R² residue. Within the alkoxy groups, the methoxy group exhibits the greatest reactivity; higher aliphatic residues such as ethoxy, and branched or cyclic residues such as cyclohexyl, produce a distinctly low reactivity in the terminating alkoxyl silyl group. It is also possible, however, to select hydrocarbon residues from the n-propyl, isopropyl, n-butyl, isobutyl, tert-butyl, n-pentyl, isopentyl, neopentyl, tert-pentyl residue, hexyl residues, heptyl residues, octyl residues such as the n-octyl residue and isooctyl residues such as the 2,2,4-trimethylpentyl residue, nonyl residues, decyl residues, dodecyl residues, alkenyl residues such as the vinyl and allyl residue; cycloalkyl residues such as cyclopentyl, cyclohexyl, cycloheptyl residues, and methylcyclohexyl residues; aryl residues, such as the phenyl and naphthyl residue; alkaryl residues, such as o-, m-, p-tolyl residues, xylyl residues and ethylphenyl residues; aralkyl residues, such as the benzyl residue and the α- and β-phenylethyl residue, are used.

In a specific embodiment of the present invention, m in formula (2) has the value 0 or 1, so that tri- or dialkoxylsilyl groups are present. The particular advantage of dialkoxysilyl groups is that the corresponding compositions are, after curing, softer and more elastic than systems containing trialkoxysilyl groups. They are therefore particularly suitable for utilization as sealants. In addition, they release less alcohol upon curing, and thus offer an application advantage from a physiological standpoint as well. With trialkoxysilyl groups, on the other hand, a higher degree of crosslinking can be achieved, which is particularly advantageous if a hard, solid substance is desired after curing. Trialkoxysilyl groups are moreover more reactive, i.e. crosslink more quickly, and thus decrease the quantity of catalyst required, and they have advantages in terms of “cold flow.”

The isocyanatosilanes listed below are particularly suitable: methyldimethoxysilylmethyl isocyanate, ethyldimethoxysilylmethyl isocyanate, methyldiethoxysilylmethyl isocyanate, ethyldiethoxysilylmethyl isocyanate, methyldimethoxysilylethyl isocyanate, ethyldimethoxysilylethyl isocyanate, methyldiethoxysilylethyl isocyanate, ethyldiethoxysilylethyl isocyanate, methyldimethoxysilylpropyl isocyanate, ethyldimethoxysilylpropyl isocyanate, methyldiethoxysilylpropyl isocyanate, ethyldiethoxysilylpropyl isocyanate, methyldimethoxysilylbutyl isocyanate, ethyldimethoxysilylbutyl isocyanate, methyldiethoxysilylbutyl isocyanate, diethylethoxysilylbutyl isocyanate, ethyldiethoxysilylbutyl isocyanate, methyldimethoxysilylpentyl isocyanate, ethyldimethoxysilylpentyl isocyanate, methyldiethoxysilylpentyl isocyanate, ethyldiethoxysilylpentyl isocyanate, methyldimethoxysilylhexyl isocyanate, ethyldimethoxysilylhexyl isocyanate, methyldiethoxysilylhexyl isocyanate, ethyldiethoxysilylhexyl isocyanate, trimethoxysilylmethyl isocyanate, triethoxysilylmethyl isocyanate, trimethoxysilylethyl isocyanate, triethoxysilylethyl isocyanate, trimethoxysilylpropyl isocyanate (e.g. GF 40, Wacker company), triethoxysilylpropyl isocyanate, trimethoxysilylbutyl isocyanate, triethoxysilylbutyl isocyanate, trimethoxysilylpentyl isocyanate, triethoxysilylpentyl isocyanate, trimethoxysilylhexyl isocyanate, triethoxysilylhexyl isocyanate.

Methyldimethoxysilylmethyl isocyanate, methyldiethoxysilylmethyl isocyanate, methyldimethoxysilylpropyl isocyanate, and ethyldimethoxysilylpropyl isocyanate, or trialkoxy analogs thereof, are particularly preferred.

The isocyanatosilane(s) are used in an at least stoichiometric quantity with respect to the hydroxyl groups of the polyol, although a slight stoichiometric excess of the isocyanatosilanes with respect to the hydroxyl groups of the polyol is preferred. This stoichiometric excess is between 0.5 and 10, by preference between 1.2 and 2 equivalents of isocyanate groups referred to the hydroxyl groups.

Organofunctional silanes of the formula Y—R—Si—(R¹)ₘ(—OR²)₃₋ₘ, where Y is equal to —OH or —NR¹, are used to manufacture, alternatively according to the present invention, the organyloxysilyl-terminated polymer P¹ from an α,ω-diisocyanate-terminated polymer X-A-X where X is equal to —NCO.

Examples of aminofunctional silanes are 3-aminopropyltrimethoxysilane, 3-aminopropyltriethoxysilane, N-2-aminoethyl-3-aminopropyltrimethoxysilane, N-2-aminoethyl-3-aminopropyltriethoxysilane, N-(β-aminoethyl)aminopropylmethyldiethoxysilane, and N-(β-aminoethyl)aminopropylmethyldimethoxysilane. Examples of hydroxyfunctional silanes are reaction products of the aforesaid aminofunctional silanes with cyclic carbonates as described in WO 96/38453, or analogous reaction products of aminofunctional silanes with lactones. The hydroxyfunctional silanes are preferably manufactured by reacting the corresponding aminosilane, having primary or secondary amino groups, with a carbonate selected from ethylene carbonate, propylene carbonate, butylene carbonate, or with a lactone selected from propiolactone, butyrolactone, or caprolactone.

It is necessary that at least one molecule of the hydroxy- or aminofunctional silane be used for each isocyanate group of the prepolymer having terminal isocyanate groups; by preference, the silane is used at a slight stoichiometric excess.

The potassium, iron, indium, zinc, bismuth, and copper compounds used as catalysts (A) for the first step in manufacturing the organyfoxysilyl-terminated polymers P¹ are preferably selected from the group consisting of carboxylates (salts of aliphatic carboxylic acids) or acetylacetonates of potassium, iron, indium, zinc, bismuth, or copper.

C₄ to C₃₆ saturated, mono- or polyunsaturated monocarboxylic acids cab be used, in particular as aliphatic carboxylic acids. Examples thereof are: arachidic acid (n-eicosanoic acid), arachidonic acid (all-cis-5,8,11,14-eicosatetraenoic acid), behenic acid (docosanoic acid), butyric acid (butanoic acid), caproleic acid (9-decenoic acid), capric acid (n-decanoic acid), caproic acid (n-hexanoic acid), caprylic acid (n-octanoic acid), cerotic acid (hexacosanoic acid), cetoleic acid (cis-1′-docosenoic acid), clupanodonic acid (all-cis-7,10,13,16,19-docosapentaenoic acid), eleostearic acid (trans-9-trans-11-cis-13-octadeca-9,11,13-trienoic acid), enanthic acid (1-hexanecarboxyfic acid), erucic acid (cis-13-docosenoic acid), gadoleic acid (9-eicosenoic acid), gondoic acid (cis-11-eicosenoic acid), hiragonic acid (6,10,14-hexadecatrienoic acid), lauric acid (dodecanoic acid), lignoceric acid (tetracosanoic acid), linderic acid (cis-4-dodecenoic acid), linoleic acid ((cis,cis)-octadeca-9,12-dienoic acid), linolenic acid ((all-cis)-octadeca-9,12,15-trienoic acid), melissic acid (triacontanoic acid), montanic acid (octacosanoic acid), stearidonic acid (cis-6-cis-9-cis-12-cis-15-octadecatetraenoic acid), myristic acid (tetradecanoic acid), myristoleic acid (cis-9-tetradecenoic acid), naphthenic acid, neodecanoic acid, obtusilic acid (cis-4-decenoic acid), caprylic acid (n-octanoic acid), neooctanoic acid, oleic acid (cis-9-octadecenoic acid), palmitic acid (n-hexadecanoic acid), palmitoleic acid (cis-9-hexadecenoic acid), parinaric acid (9,11,13,15-octadecatetraenoic acid), petroselinic acid (cis-6-octadecenoic acid), physeteric acid (5-tetradecenoic acid), punicic acid (cis-9-trans-11-cis-13-octadeca-9,11,13-trienoic acid), scoliodonic acid (cis-5-cis-11-cis-14-eicosatrienoic acid), selacholeic acid (15-tetracosenoic acid), stearic acid (n-octadecanoic acid), tricosanoic acid, tsuzuic acid (cis-4-tetradecenoic acid), trans-vaccenic acid (trans-11-octadecenoic acid), palmitoleic acid (9-hexadecenoic acid). In addition to the acetylacetonates, chelates of other p-dicarbonyl compounds of potassium, iron, indium, zinc, bismuth, or copper can also be used. Acetoacetic acid alkyl esters, dialkyl malonates, benzoylacetic esters, dibenzoylmethane, benzoylacetone, and dehydroacetoacetic acid may be recited concretely.

The catalysts (A) are used in quantities from 0.01 to 3.0 parts by weight, based on 100 parts by weight polymer P¹. The reaction is preferably accomplished at temperatures from 0 to 150° C., particularly preferably at 25 to 100° C., and at a pressure of the ambient atmosphere, i.e. approximately 900 to 1100 hPa.

The organyloxylsilyl-terminated polymers P¹ manufactured in this fashion are stabile with respect to atmospheric moisture, and can be used particularly advantageously for the manufacture and use of one-component, moisture-curing adhesives, sealants, or coating agents.

For this purpose, silane condensation catalysts (B) are added, in a second step, to the organyloxysilyl-terminated polymers P¹. These silane condensation catalysts are selected from the group consisting of compounds of elements of the third main group and/or fourth subgroup of the periodic system of the elements, and heterocyclic organic amines, amine complexes of the element compounds, or mixtures thereof. The silane condensation catalysts (B) are therefore substantially a combination of at least one compound that contains at least one element of the third main group and/or fourth subgroup of the periodic system of the elements, with at least one heterocyclic organic amine and/or at least one amine complex of at least one compound that contains at least one element of the third main group and/or fourth subgroup of the periodic system of the elements. A “combination” is understood for purposes of the present invention both as juxtaposed presence of the respective element compound and an amine, and as molecular compounds of any kind between an element compound and amine, a molecular compound to be understood as a congregation of at least two molecules on the basis of secondary valence bonds such as Van der Waals forces, dipole orientation, hydrogen bridge bonding, and the like. The term “complex” can be considered, in the context of the present invention, to be equivalent to “molecular compound.” The third main group of the period system encompasses, for purposes of the present invention, the elements boron, aluminum, gallium, indium, thallium. The fourth subgroup of the periodic system is to be understood as the group encompassing the elements titanium, zirconium, hafnium.

In a particularly preferred embodiment of the present invention, the silane condensation catalysts (B) are
i) a combination of at least one titanium compound and/or aluminum compound with at least one heterocyclic organic amine, or
ii) the silane condensation catalysts (B) are at least one complex compound containing boron and an amine,
   or the silane condensation catalysts (B) are a mixture of i) and ii).

The titanium or aluminum compounds used are by preference chelates thereof based on β-dicarbonyl compounds. Examples of suitable β-dicarbonylcompounds are acetylacetone, acetoacetic acid alkyl esters, dialkyl malonates, benzoylacetic esters, dibenzoylmethane, benzoylacetone, dehydroacetoacetic acid.

Examples of usable heterocyclic organic amines are N-methylpyrrolidine, N-methylpiperidine, N,N-dimethylpiperazine, diazabicyclooctane (DABCO), N-(2-hydroxyethoxyethyl)-2-azanorbornane, 1,8-diazadicyclo(5.4.0)undecene-7 (DBU), N-dodecyl-2-methylimidazole, N-methylimidazole, 2-ethyl-2-methylimidazole, N-methylmorpholine, bis(2-(2,6-dimethyl-4-morpholino)ethyl)-(2-(4-morpholino)ethyl)amine, bis(2-(2,6-dimethyl-4-morpholino)ethyl)-(2-(2,6-diethyl-4-morpholino)ethyl)amine, tris(2-(4-morpholino)ethyl)amine, tris(2-(4-morpholino)propyl)amine, tris(2-(4-morpholino)butyl)amine, tris(2-(2,6-dimethyl-4-morpholino)ethyl)amine, tris(2-(2,6-diethyl-4-morpholino)ethyl)amine, tris(2-(2-methyl-4-morpholino)ethyl)amine, tris(2-(2-ethyl-4-morpholino)ethyl)amine, dimethylaminopropylmorpholine, bis-(morpholinopropyl)methylamine, diethylaminopropylmorpholine, bis-(morpholinopropyl)ethylamine, bis-(morpholinopropyl)propylamine, morpholinopropylpyrrolidone, N-morpholinopropyl-N′-methyl-piperazine, dimorpholinodiethyl ether (DMDEE), or di-2,6-dimethylmorpholinoethyl)ether.

In addition to the aforesaid heterocyclic amines, amine complexes made up of boron halides, in particular boron trifluoride, or boron alkylene, are also usable in preferred fashion according to the present invention as silane condensation catalysts (B). Suitable in this context as amine components are both the aforesaid heterocyclic amines and simple lower alkylamines or diamines; concrete mention may be made here of ethylamine, propylamine, butylamine, and the aminosilanes recited elsewhere.

The silane condensation catalysts (B) that are used are selected, for example, from the group of titanium (diisopropoxide)bis(acetylacetonate), titanium(IV) oxide acetylacetonate, aluminum acetylacetonate, 1,4-diazabicyclo[2,2,2]octane, N,N-dimethylpiperazine, 1,8-diazabicyclo[5.4.0]undec-7-ene, dimorpholinodimethyl ether, boron halides or boron alkyls, amine complexes of boron halides or boron alkyls, or mixtures of the aforesaid compounds and/or complexes.

The silane condensation catalysts (B) are used in quantities from 0.01 to 3.0 parts by weight, based on 100 parts by weight polymer P′. The reaction is preferably accomplished at temperatures from 0 to 150° C., and particularly preferably at 25 to 100° C., and at a pressure of the ambient atmosphere, i.e. approximately 900 to 1100 hPa.

The adhesive and sealant preparations according to the present invention can also contain, in addition to the aforesaid organyloxysilyl-terminated polymers P¹, further adjuvants and additives that impart to these preparations improved elastic properties, improved elastic recovery, a sufficiently long processing time, a fast curing time, and low residual tack. Included among these adjuvants and additives are, for example, plasticizers, stabilizers, antioxidants, fillers, reactive diluents, drying agents, adhesion promoters and UV stabilizers, rheological adjuvants, color pigments or color pastes, and/or optionally also, to a small extent, solvents.

Suitable as plasticizers are, for example, adipic acid esters, azelaic acid esters, benzoic acid esters, butyric acid esters, acetic acid esters, esters of higher fatty acids having approximately 8 to approximately 44 carbon atoms, esters of OH-group-carrying or epoxidized fatty acids, fatty acid esters and fats, glycolic acid esters, phosphoric acid esters, phthalic acid esters, linear or branched alcohols containing 1 to 12 carbon atoms, propionic acid esters, sebacic acid esters, sulfonic acid esters (e.g. Mesamoll, alkylsulfonic acid phenyl ester, Bayer company), thiobutyric acid esters, trimellitic acid esters, citric acid esters, and esters based on nitrocellulose and polyvinyl acetate, as well as mixtures of two or more thereof. The asymmetrical esters of adipic acid monooctyl ester with 2-ethylhexanol (Edenol DOA, Cognis Deutschland GmbH, Düsseldorf), or also esters of abietic acid, are particularly suitable.

Suitable among the phthalic acid esters are, for example, dioctyl phthalate (DOP), dibutyl phthalate, diisoundecyl phthalate (DIUP), or butylbenzyl phthalate (BBP) or their derived hydrogenated derivatives, and among the adipates, dioctyl adipate (DOA), diisodecyl adipate, diisodecyl succinate, or dibutyl sebacate or butyl oleate.

Also suitable as plasticizers are the pure or mixed ethers of monofunctional, linear, or branched C₄₋₁₆ alcohols or mixtures of two or more different ethers of such alcohols, for example dioctyl ether (obtainable as Cetiol OE, Cognis Deutschland GmbH, Dusseldorf).

Also suitable as plasticizers are end-capped polyethylene glycols, for example C₁₋₄-alkyl ethers of polyethylene glycol or of polypropylene glycol, in particular the dimethyl and diethyl ethers of diethylene glycol and dipropylene glycol, as well as mixtures of two or more thereof.

“Stabilizers” for purposes of this invention are to be understood as antioxidants, UV stabilizers, or hydrolysis stabilizers. Examples thereof are the commercially usual sterically hindered phenols and/or thioethers and/or substituted benzotriazoles, for example Tinuvin 327 (Ciba Specialty Chemicals), and/or amines of the hindered amine light stabilizer (HALS) type, for example Tinuvin 770 (Ciba Specialty Chemicals). It is preferred in the context of the present invention if a UV stabilizer that carries a silyl group, and that is incorporated into the end product upon crosslinking or curing, is used. The products Lowilite 75, Lowilite 77 (Great Lakes company, USA) are particularly suitable for this purpose. Benzotriazoles, benzophenones, benzoates, cyanoacrylates, acrylates, sterically hindered phenols, phosphorus, and/or sulfur can also be added. The preparation according to the present invention can contain up to approximately 2 wt %, by preference approx. 1 wt % stabilizers. In addition, the preparation according to the present invention can further contain up to approximately 7 wt %, in particular up to approx. 5 wt % antioxidants.

The preparation according to the present invention can additionally contain fillers. Suitable here are, for example, chalk, lime powder, precipitated and/or pyrogenic silicic acid, zeolites, bentonites, magnesium carbonate, diatomite, alumina, clay, talc, titanium oxide, iron oxide, zinc oxide, sand, quartz, flint, mica, glass powder, and other ground mineral substances. Organic fillers can also be used, in particular carbon black, graphite, wood fibers, wood flour, sawdust, cellulose, cotton, pulp, cotton, wood chips, chopped straw, chaff, ground walnut shells, and other chopped fibers. Short fibers such as glass fibers, glass filament, polyacrylonitrile, carbon fibers, Kevlar fibers, or polyethylene fibers can also be added. Aluminum powder is likewise suitable as a filler.

The pyrogenic and/or precipitated silicic acids advantageously have a BET surface area from 10 to 90 m²/g. When they are used, they do not cause any additional increase in the viscosity of the preparation according to the present invention, but do contribute to strengthening the cured preparation.

It is likewise conceivable to use pyrogenic and/or precipitated silicic acids having a higher BET surface area, advantageously 100 to 250 m²/g, in particular 110 to 170 m²/g, as a filler. Because of the greater BET surface area, the same effect, e.g. strengthening the cured preparation, is achieved with a smaller weight proportion of silicic acid. Further substances can thus be used to improve the preparation according to the present invention in terms of different requirements.

Also suitable as fillers are hollow spheres having a mineral shell or a plastic shell. These can be, for example, hollow glass spheres that are obtainable commercially under the trade names Glass Bubbles®. Plastic-based hollow spheres, e.g. Expancel® or Dualite®, are described e.g. in EP 0 520 426 B1. They are made up of inorganic or organic substances and each have a diameter of 1 mm or less, preferably 500 μm or less.

Fillers that impart thixotropy to the preparations are preferred for many applications. Such fillers are also described as rheological adjuvants, e.g. hydrogenated castor oil, fatty acid amides, or swellable plastics such as PVC. In order to be readily squeezable out of a suitable dispensing apparatus (e.g. a tube), such compositions possess a viscosity from 3000 to 15,000, preferably 40,000 to 80,000 mPas, or even 50,000 to 60,000 mPas.

The fillers are used by preference in a quantity from 1 to 80 wt %, by preference from 5 to 60 wt %, based on the total weight of the preparation.

Examples of suitable pigments are titanium dioxide, iron oxides, or carbon black.

In order to enhance shelf life even further, it is often advisable to further stabilize the preparations according to the present invention with respect to moisture penetration using drying agents. A need occasionally also exists to lower the viscosity of the adhesive or sealant according to the present invention for specific applications, by using a reactive diluent. All compounds that are miscible with the adhesive or sealant with a reduction in viscosity, and that possess at least one group that is reactive with the binder, can be used as reactive diluents.

The following substances can be used, for example, as reactive diluents: polyalkylene glycols reacted with isocyanatosilanes (e.g. Synalox 100-50B, Dow), carbamatopropyltrimethoxysilane, alkyltrimethoxysilane, alkyltriethoxysilane, methyltrimethoxysilane, methyltriethoxysilane, and vinyltrimethoxysilane (Dynasylan VTMO, Evonik or Geniosil XL 10, Wacker), vinyltriethoxysilane, phenyltrimethoxysilane, phenyltriethoxysilane, octyltrimethoxysilane, tetraethoxysilane, vinyldimethoxymethylsilane (XL12, Wacker), vinyltriethoxysilane (GF56, Wacker), vinyltriacetoxysilane (GF62, Wacker), isooctyltrimethoxysilane (10 Trimethoxy), isooctyltriethoxysilane (10 Triethoxy, Wacker), N-trimethoxysilylmethyl-O-methyl carbamate (XL63, Wacker), N-dimethoxy(methyl)silylmethyl-O-methyl carbamate (XL65, Wacker), hexadecyltrimethoxysilane, 3-octanoylthio-1-propyltriethoxysilane, aminosilanes such as 3-aminopropyltrimethoxysilane (Dynasylan AMMO, Evonik or Geniosil GF96, Wacker), bis(trimethoxysilylpropyl)amine (Silquest® A1170, GE Silicones), and partial hydrolysates of the aforesaid compounds.

A plurality of the aforesaid silane-functional reactive diluents have at the same time a drying and/or adhesion-promoting effect in the preparation. These reactive diluents are used in quantities between 0.1 and 15 wt %, by preference between 1 and 5 wt %, based on the entire composition of the preparation.

Also suitable as adhesion promoters, however, are so-called tackifying agents, such as hydrocarbon resins, phenol resins, terpene-phenolic resins, resorcinol resins or derivatives thereof, modified or unmodified resin acids or resin esters (abietic acid derivatives), polyamines, polyaminoamides, anhydrides, and anhydride-containing copolymers. The addition of polyepoxide resins in small quantities can also improve adhesion on many substrates. The solid epoxy resins having a molecular weight of over 700, in finely ground form, are then preferably used for this. If tackifying agents are used as adhesion promoters, their nature and quantity depend on the adhesive/sealant composition and on the substrate onto which it is applied. Typical tackifying resins (tackifiers) such as, for example, terpene-phenolic resins or resin acid derivatives, are used in concentrations between 5 and 20 wt %; typical adhesion promoters such as polyamines, polyaminoamides, or phenolic resins or resorcinol derivatives are used in the range between 0.1 and 10 wt %, based on the entire composition of the preparation.

Manufacture of the preparation according to the present invention occurs in accordance with known methods, by intimate mixing of the constituents in suitable dispersing units, e.g. high-speed mixers, kneaders, planetary mixers, planetary dissolvers, internal mixers, so-called Banbury mixers, double-screw extruders, and similar mixing units known to one skilled in the art.

A preferred embodiment of the preparation according to the present invention can contain:
5 to 50 wt %, preferably 10 to 40 wt %, of one or more compounds of the organyloxysilyl-terminated polymers P¹ according to the present invention;
0.01 to 3.0 parts by weight each of catalyst (A) and of silane condensation catalyst (B), based on 100 parts by weight polymer
0 to 30 wt %, preferably less than 20 wt %, particularly preferably less than 10 wt % plasticizer;
0 to 80 wt %, preferably 20 to 60 wt %, particularly preferably 30 to 55 wt % fillers.
   The embodiment can also contain further adjuvants and additives.

The totality of all constituents adds up to 100 wt %; the sum of the principal constituents listed above need not alone add up to 100 wt %.

The preparations according to the present invention cure with ambient atmospheric moisture to yield low-modulus polymer substances, so that the latter are suitable as low-modulus, moisture-curing adhesive and sealant preparations and coating agents that are free of organic tin compounds. A further subject of the present invention is therefore the use of a preparation, containing one or more silane-functional polymers P¹ and manufacturable according to a method according to the present invention, as an adhesive, sealant, or coating agent.

The invention will be further explained in the exemplifying embodiment that follows; the example selected is not intended to represent any limitation on the scope of the subject matter of the invention.

### EXAMPLES

### Manufacture of the Polymers

282 g (15 mmol) polypropylene glycol 18000 (OH no.=6.0) was dried under vacuum at 100° C. in a 500 ml three-neck flask. 0.1 g bismuth carboxylate (Borchi Kat 24, Borchers co.) was added under a nitrogen atmosphere at 80° C., and 7.2 g (32 mmol) 3-isocyanatopropyltrimethoxysilane (% NCO=18.4) was then added to it. After one hour of stirring at 80° C., the resulting polymer was cooled and had 6 g vinyltrimethoxysilane added to it.

Properties of the Polymer Films

In an aluminum dish with a diameter of 50 mm, 5 g prepolymer was mixed with 0.05 g AMMO and 0.05 g A1170, as well as 0.025 g of the respective catalyst. The skin-over time (SOT) and time until formation of a tack-free layer (tack-free time, TFT) were determined for these mixtures (at 23° C. and 50% relative humidity in each case). In addition, the aforementioned mixtures were applied, at a layer thickness of 2 mm, onto glass plates over which polyether film had been stretched. After 7 days of storage (23° C., 50% relative humidity), test specimens (S2 test specimens) were punched out of these films and mechanical data (modulus of elasticity at 50% elongation, elongation at fracture, and tensile strength (“breaking strength”)) were determined on the basis of DIN EN 27389 and DIN EN 28339.

As is evident from the results compiled in Table 1 below, the SOT/TFT can be adapted to requirements within wide limits using the polymer compositions according to the present invention, and the mechanical properties of the tin-free polymer films manufactured according to the present invention are at least equivalent to those of tin-containing ones in accordance with the existing art.

TABLE 1

| | Example | | | | |
|---|---|---|---|---|---|
| | 1 | | | | |
| | (comparison) | 2 | 3 | 4 | 5 |
| Catalyst | DBTL | Mixture¹⁾ | Boron | Boron | Mixture²⁾ |
| | | of 1% ea. | trifluoride/ethylamine | trifluoride/ | of 1% ea. |
| | | Ti/DBU | complex 95% | GF96 | Al/DBU |
| | | | | complex | |
| SOT/TFT | 30 min | 15 min | 5 h | 5 h | 20 |
| Breaking strength | 0.62 | 0.61 | 0.67 | 0.76 | 0.59 |
| (N/mm²) | | | | | |
| Elongation (%) | 49 | 66 | 54 | 68 | 56 |
| E-50 modulus | 0.66 | 0.52 | 0.63 | 0.64 | 0.60 |
| (N/mm²) | | | | | |

Notes:
¹⁾Titanium (diisopropoxide)bis(acetylacetonate) was used as a Ti compound.
²⁾Aluminum tris(acetylacetonate) was used as an Al compound.

General Protocol for Manufacturing the Curable Adhesive/Sealant Preparations According to the Present Invention:

27.40 parts by weight of the polymer mixture were intimately mixed in an agitator vessel, using a SpeedMixer, with 15 parts by weight Mesamoll.
Into the mixture thereby obtained, 45.05 parts by weight calcium carbonate (Omya 302, “ultrafine ground calcium carbonate”), 1.5 parts vinyltrimethoxysilane (“VTMO”, Wacker Geniosil XL10), 1.0 parts by weight 3-aminopropyltrimethoxysilane (“AMMO”, Wacker Geniosil GF96), and 0.05 parts by weight catalyst were introduced sequentially, and the resulting batch was intimately mixed for 30 s in a SpeedMixer.
The following were used as catalysts:
Catalyst 1: DBTL (comparison)
Catalyst 2: Ti/DBU, 1% each (see note 1 to Table 1)
Catalyst 3: Boron trifluoride/ethylamine complex 95%
Catalyst 4: Boron trifluoride/GF96 complex
Catalyst 5: Mixture of 1% each Al/DBU (see note 2 to Table 1)

Test Conditions

Tensile shear strength values (“strength values”) on wood/wood, wood/aluminum, and wood/PMMA adhesive bonds were ascertained for these mixtures. Prior to the tensile test, the adhesively bonded test specimens were stored for 7 days in a standard climate (23° C., 50% relative humidity).

The aforementioned mixtures were also applied, at a layer thickness of 2 mm, onto glass plates over which polyether film had been stretched. After 7 days of storage (23° C., 50% relative humidity), test specimens (S2 test specimens) were punched out of these films and mechanical data (modulus of elasticity at 50 and 100% elongation, elongation at fracture, tensile strength, and recovery characteristics) were determined on the basis of DIN EN 27389 and DIN EN 28339.

TABLE 2
Assembly adhesive formulations

| Example | 6 | 7 | 8 | 9 | 10 |
|---|---|---|---|---|---|
| Polymer PPG 18K | 27.40 | 27.40 | 27.40 | 27.40 | 27.40 |
| Mesamoll | 15.00 | 15.00 | 15.00 | 15.00 | 15.00 |
| Omyabond 302 | 55.05 | 55.05 | 55.05 | 55.05 | 55.05 |
| VTMO XL 10 | 1.50 | 1.50 | 1.50 | 1.50 | 1.50 |
| AMMO GF 96 | 1.00 | 1.00 | 1.00 | 1.00 | 1.00 |
| Catalyst 1 | 0.05 | | | | |
| Catalyst 2 | | 0.05 | | | |
| Catalyst 3 | | | 0.05 | | |
| Catalyst 4 | | | | 0.05 | |
| Catalyst 5 | | | | | 0.05 |
| Film method: | | | | | |
| SOT (min) | 24 | 22 | 48 | 36 | 30 |
| TFT (h) | <24 | <24 | <24 | <24 | <24 |
| Breakage (N/mm²) | 3.10 | 2.95 | 2.99 | 2.7 | 3.01 |
| Elongation (%) | 138 | 145 | 130 | 140 | 145 |
| E-50 (N/mm²) | 1.72 | 1.8 | 1.6 | 1.68 | 1.75 |
| E-100 (N/mm²) | 2.75 | 2.8 | 2.6 | 2.75 | 2.8 |
| Strength values (N/mm²) | | | | | |
| Wood/wood | 5.04 | 5.2 | 5.12 | 5.3 | 5.01 |
| Wood/aluminum | 2.49 | 2.8 | 2.9 | 3.02 | 2.98 |
| Wood/PMMA | 0.5 | 1.3 | 0.64 | 0.99 | 1.02 |

The compositions according to the present invention in some cases exhibit a slightly extended SOT as compared with DBTL-containing preparations, but in terms of the important properties of TFT and elongation, and tensile shear strength on adhesive bonds, they exhibit at least equivalent and in some cases improved mechanical properties. A substantial advantage of the compositions according to the present invention as compared with the preparations in accordance with the existing art (example 1) is the absence of organic tin compounds.

1. A method for manufacturing crosslinkable preparations, wherein in a first step, α,ω-difunctional organic polymers of formula (1)
X-A-X (1)
are reacted with organofunctional silanes of formula (2)
Y—R—Si—(R¹)ₘ(—OR²)₃₋ₘ (2),
in the presence of catalysts (A) selected from the group consisting of compounds of potassium, iron, indium, zinc, bismuth, and copper, to yield organyloxysilyl-terminated polymers P¹, wherein
R denotes a divalent, optionally substituted hydrocarbon residue having 1 to 12 carbon atoms, which can be interrupted by heteroatoms,
R¹ can be the same or different, and denotes monovalent, optionally substituted hydrocarbon residues having 1 to 12 carbon atoms, which can be interrupted by heteroatoms,
R² can be the same or different, and denotes monovalent, optionally substituted hydrocarbon residues having 1 to 12 carbon atoms, which can be interrupted by heteroatoms, A denotes a divalent, optionally substituted hydrocarbon radical having at least 6 carbon atoms, which can be interrupted by heteroatoms, and
m is equal to 0, 1, or 2,
X is a hydroxyl group and Y is an isocyanate group, or X is an isocyanate group and Y is a hydroxyl group or a primary or secondary amino group, and in a second step,
the polymers P¹ obtained in the first step are mixed with a silane condensation catalyst (B) selected from the group consisting of compounds of elements of the third main group and/or of the fourth subgroup of the periodic system and heterocyclic organic amines, amine complexes of the element compounds, or mixtures thereof, and optionally with further substances (C), the preparations being free of organic tin compounds.

2. The method according to claim 1, wherein the organic polymers of formula (1) are polymer compounds based on polyethers or polyesters.

3. The method according to claim 1 or 2, wherein m in formula (2) has the value 0 or 1.

4. The method according to claim 1, wherein the catalyst (A) is a carboxylate or acetylacetonate of potassium, iron, indium, zinc, bismuth, or copper.

5. The method according to claim 1, wherein titanium compounds, aluminum compounds, and/or boron compounds are utilized for the silane condensation catalysts (B) that are used.

6. The method according to claim 1, wherein the silane condensation catalysts (B) used are selected from the group of titanium diisopropoxide bis(acetylacetonate), titanium(IV) oxide acetylacetonate, aluminum acetylacetonate, 1,4-diazabicyclo[2,2,2]octane, N,N-dimethylpiperazine, 1,8-diazabicyclo[5.4.0]undec-7-ene, dimorpholinodimethyl ether, boron halides or boron alkyls, amine complexes of boron halides or boron alkyls, or mixtures of the aforesaid compounds and/or complexes.

7. The method in accordance with claim 1, wherein the silane condensation catalyst (B) is used in quantities from 0.01 to 3.0 parts by weight, based on 100 parts by weight of polymer P¹.

8. The method in accordance with claim 1, wherein the further substances (C) are selected from fillers, crosslinkers, plasticizers, and further adjuvants and additives, or mixtures thereof.

9. The method in accordance with one claim 1, wherein the second step is carried out at temperatures from 10 to 100° C. and at a pressure of the surrounding atmosphere of approximately 900 to 1100 hPa.

10. An adhesive, sealant, or coating agent containing one or more silane-functional polymers P¹ according to claim 1.

11. A method for manufacturing crosslinkable preparations, comprising:
in a first step reacting α,ω-difunctional organic polymers of formula (1)
X-A-X (1)
with organofunctional silanes of formula (2)
Y—R—Si—(R¹)ₘ(—OR²)₃₋ₘ (2),
in the presence of catalysts selected from the group consisting of compounds of potassium, iron, indium, zinc, bismuth, and copper, to yield organyloxysilyl-terminated polymers P¹, wherein
R denotes a divalent, optionally substituted hydrocarbon residue having 1 to 12 carbon atoms, which can be interrupted by heteroatoms,
R¹ can be the same or different, and denotes monovalent, optionally substituted hydrocarbon residues having 1 to 12 carbon atoms, which can be interrupted by heteroatoms,
R² can be the same or different, and denotes monovalent, optionally substituted hydrocarbon residues having 1 to 12 carbon atoms, which can be interrupted by heteroatoms,
A denotes a divalent, optionally substituted hydrocarbon radical having at least 6 carbon atoms, which can be interrupted by heteroatoms,
m is equal to 0, 1, or 2,
X is a hydroxyl group and Y is an isocyanate group, or X is an isocyanate group and Y is a hydroxyl group or a primary or secondary amino group; and
in a second step mixing the polymers P¹ obtained in the first step with a silane condensation catalyst (B) selected from at least one of compounds of elements of the third main group of the periodic table, the fourth subgroup of the periodic table, heterocyclic organic amines, amine complexes of elements of the third main group of the periodic table, amine complexes of elements of the fourth subgroup of the periodic table, and optionally further substances (C);
wherein the crosslinkable preparation is free of organic tin compounds.

12. The method of claim 11 wherein the silane condensation catalyst (B) is selected from compounds of boron, aluminum, gallium, indium, thallium, titanium, zirconium, hafnium, heterocyclic organic amines, amine complexes of boron, aluminum, gallium, indium, thallium, titanium, zirconium, hafnium, or mixtures thereof.
